(19) United States
(12) Patent Application Publication
(10) Pub. No.: US 2013/0191516 A1
(43) Pub. Date: Jul. 25, 2013

(54) AUTOMATED CONFIGURATION ERROR DETECTION AND PREVENTION

(71) Applicant: CHRISTOPHER T. SEARS, Avondale Estates, GA (US)

(72) Inventor: CHRISTOPHER T. SEARS, Avondale Estates, GA (US)

(73) Assignee: SunGard Availability Services LP, Wayne, PA (US)

(21) Appl. No.: 13/353,652

(22) Filed: Jan. 19, 2012

(51) Int. Cl. G06F 15/177

(52) U.S. Cl. 709/220

(57) ABSTRACT

A Configuration Management System (or CMS) assists human operators with administering infrastructure elements in a data center. Configuration state information is collected and stored as a hierarchical set of features and feature attributes. The CMS save a configuration snapshot immediately before a change is implemented and immediately after a change. Comparing the pre-change and post-change configuration states, the CMS can automatically identify potential configuration errors and help better manage the consequences of implementing a change.

### TECHNICAL FIELD

This patent relates to information technology and in particular to detecting and preventing errors in the configuration of data centers.

### BACKGROUND

The data center model for providing Information Technology (IT) services allows customers to run their business data processing systems and applications from a centralized facility. Solutions include hosting services, application services, e-mail and collaboration services, network services, managed security services, storage services and replication services. These solutions are suited to organizations that require a secure, highly available and redundant environment.

Such data centers can be located on the customer's premises and can be operated by customer employees. However, the users of data processing equipment increasingly find a remotely hosted service model to be the most flexible, easy, and affordable way to access the data center functions and services they need. By moving physical infrastructure and applications to cloud based servers accessible over the Internet or private networks, customers are free to specify equipment that exactly fits their requirements at the outset, while having the option to adjust with changing future needs on a “pay as you go” basis.

This promise of scalability allows expanding and reconfiguring servers and applications as needs grow, without having to spend for unneeded resources in advance. Additional benefits provided by professional level cloud service providers include access to the most up to date equipment and software with superior performance, security features, disaster recovery services, and easy access to information technology consulting services.

### SUMMARY

As data center capacity expands to support increasing demand, the complexity of configuring the various hardware and software infrastructure elements that make up the data center environment also grows. As a result, it becomes increasingly difficult to implement configuration changes in a way that does not have unintended consequences. It is not uncommon for a list of the equipment in even a small data center and configuration settings to be a document that is many, many pages long with thousands of pieces of discrete information contained therein.

In the approach preferred here, a Configuration Management System (or CMS) assists human operators with administering the infrastructure in their data center environments by collecting and analyzing configuration data. One major challenge is maintaining an accurate representation of what the correct or desired configuration state should be for a given infrastructure element, and reconcile that against the actually configured state. By representing the state information as a hierarchical set of configuration attributes and values, the CMS can obtain and then save such state information immediately before a change is implemented and immediately after a change. Comparing the pre-change and post-change configuration states, the CMS can automatically identify potential configuration errors and thus help the administrator better manage the consequences of implementing a change.

The CMS is a software program used by an administrative user to request, track and automate the configuration of a data center. The CMS may be physically located local to or remote from the data center itself.

One of the functions performed by the CMS is to periodically obtain configuration information concerning the data center. The data center consists of a number of data processing infrastructure elements such as, but not limited to networking devices, physical machines, virtual machines, storage systems, servers, operating systems and applications.

The specific configuration information collected by the CMS depends on the type of infrastructure elements. For example a file server may return configuration information such as the amount of memory, local disk storage, Operating System (OS) type, OS version, and OS patches installed, applications installed, application versions, and a list of authorized user accounts. A router, on the other hand, may return a list of active interfaces, interface configurations, and routing table information.

The infrastructure elements thus have a live, running configuration state that is exposed to and can be queried via the CMS. The CMS can then present this information in a form that is viewable by the administrative user.

More importantly for the purposes described herein, the CMS also captures this live configuration information at a specific point in time and stores it as a configuration snapshot in a database. These snapshots are preferably organized into a hierarchical model of the infrastructure elements in the data center, configuration attributes for each infrastructure element, and associated values for the attributes.

At some point in time the administrative user wishes to implement a change to the configuration of the data center. The CMS coordinates the manner in which the change is made. Specifically, before allowing the user to implement the change, the user first requests the CMS open a maintenance window for one or more infrastructure elements.

Once a maintenance window is open, the CMS treats the specified infrastructure elements as being in a special maintenance mode where the administrative user has exclusive rights to perform changes. The CMS obtains a current snapshot (either by using one recently taken, or better still, by taking a new snapshot). This snapshot then becomes a pre-change snapshot. In a preferred arrangement, automated updates or changes that might otherwise by implemented by the CMS or other support systems are suppressed while in this maintenance mode.

The user then implements the change (either manually or with tools provided by the CMS), and then notifies the CMS that the configuration change(s) are complete. The CMS then obtains another new snapshot which becomes a post-change snapshot.

The CMS then compares the pre-change and post-changes snapshots to extract data indicating which configuration attributes, and the values associated with those attributes, are now different as a result of the change. These differences are then displayed to the administrative user, who can now better appreciate the impact of having made the change, and if any undesirable side effects have occurred as a result.

If corrective action is required to compensate for any unexpected configuration differences, the administrative user will notify the CMS that further changes must be implemented. The administrative user then performs the corrective action and notifies the CMS when the actions are complete. A new post-change snapshot is then obtained, analyzed for differences and presented to the administrative user.

The above process repeats until the administrative user confirms that all differences in configuration are intended or benign. At this point the CMS closes the maintenance window. The involved infrastructure elements are no longer considered to be in maintenance mode, allowing automated updates or administrative user to resume normal operation.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a high level diagram of a service provider level data processing environment that includes several data centers operated as a service for customers.

FIG. 2 is an example configuration snapshot.

FIG. 3 illustrates a process implemented by a Configuration Management System (CMS) and interaction with an administrative user.

### DETAILED DESCRIPTION OF AN EMBODIMENT

1. Example Data Center

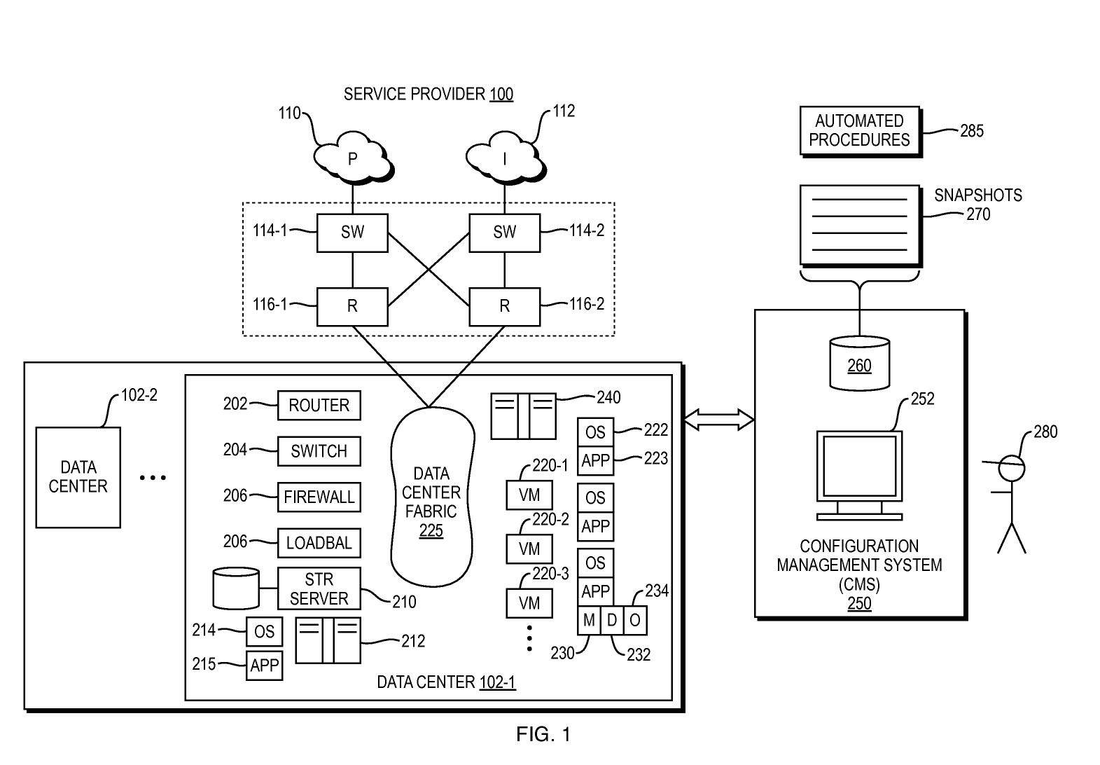

FIG. 1 is a high level diagram of a typical information technology (IT) environment in which the improved Configuration Management System (CMS) procedures described herein may be used. It should be understood that this is but one example IT environment and many others are possible.

The illustrated IT environment is implemented at a service provider location 100 which makes available one or more data centers 102-1, 102-2 . . . to one or more service customers. The service provider environment includes connections to various networks such as a private network 110 and the Internet 112 through various switches 114-1, 114-2 and or routers 116-1, 116-2. The data center level switches 114 and routers 116 provide all ingress and egress to the several various data centers 102-1, 102-2 that are hosted at the particular service provider location 100.

In some implementations, these data center level switches 114 and routers 116 are considered to be part of the service provider's infrastructure and thus are not considered to be part of the infrastructure elements that are configurable by the customer directly or considered to be part of the data center 102. It is, for example, possible that the details of the operation of the service provider level switches 114 and routers 116 are kept hidden from and are not of concern to the customer. However, in other instances the data center level switches and routers (or portions thereof) may very well be part of the service customer's infrastructure elements and therefore configurable by the customer.

An example data center 102 includes a number of physical and/or virtual infrastructure elements. These infrastructure elements may include, but are not limited to, networking equipment such as routers 202, switches 204, firewalls 206, and load balancers 208, storage subsystems 210, and servers 212. The servers 212 may include web servers, database servers, application servers, storage servers, security appliances or other type of machines. Each server 212 typically includes an operating system 214, application software 215 and other data processing services, features, functions, software, and other aspects.

Most modern data centers also support virtual machine clusters 240 that may be implemented on one or more physical machines, such that multiple virtual machines 220-1, 220-2, 220-3 are also considered to be part of the data center 102. Each of the VM's 220 also includes an operating system 222, applications 223 and has access to various resources such as memory 230, disk storage 232 and other resources 234, such as virtual local area networks, firewalls, and so forth.

A data center fabric 225 interconnects the various infrastructure elements in the data center 102 and is not shown in detail for the sake of clarity.

It should also be understood that while shown only a single type of each infrastructure element is shown, a given data center may have multiple routers 202, switches 204, firewalls 206, load balancers 208, storage servers 210, application servers 212, virtual machines 220 and virtual machine clusters 240 and/or other types of infrastructure elements that are not shown or mentioned in detail or at all herein. For example, the virtual machine 220 infrastructure elements may provide functions such as virtual routers, virtual network segments, with each segment having one or more virtual machines operating as servers and/or other virtualized resources such as virtual firewalls.

An administrative user 280 has access to a Configuration Management System 250. The CMS 250 allows the administrator user 280 to interact with and configure the infrastructure elements in the data center 102.

The CMS 250 may itself be located in the same physical location as the data center 102, elsewhere the premises of the service provider 100, at the service customer premises, or remotely located and securely accessing the data center through either the private network 110 or the Internet 112.

The CMS 250 includes a user input/output device 252 such as a personal computer and information storage, preferably taking the form of a configuration database 260, as will be understood and described in more detail shortly. The database 260 stores several different types of information concerning the data center 102. Of particular interest here is that the database 260 stores configuration snapshots 270 consisting of live configuration information taken from and relating to the various infrastructure elements in the data center 102.

The configuration management system 250 may also include other aspects such as automated procedure systems 285 that perform functions such as security, maintenance, automatic updates and so forth that normally occur without intervention from the administrator user 280. Automated systems 285 include but are not limited to monitoring systems, alerting services, intrusion detection systems, and log analysis services.

2. Automated Change Management and Error Detection Process

A. Configuration Snapshot

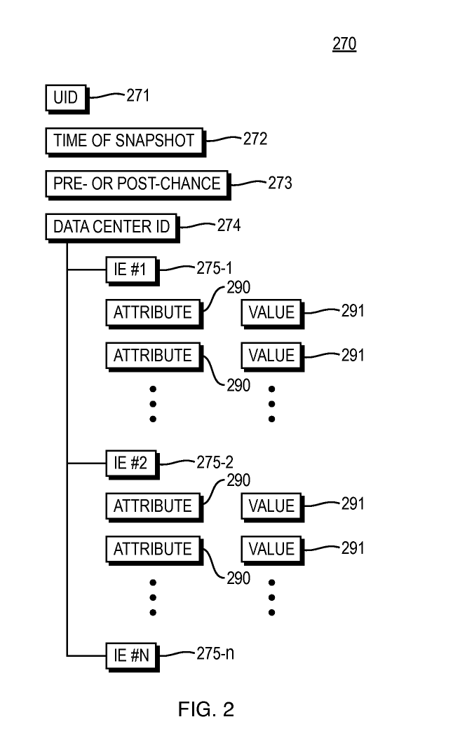

The Configuration Management System (CMS) 250 thus maintains for each data center 102 one or more current snapshots 270. The CMS 250 is therefore capable of capturing live, running configuration information from the data center infrastructure elements and storing this configuration information. These configuration information snapshots may take a general hierarchical form as shown in FIG. 2. A typical snapshot consists of a hierarchal set of attributes and values. The snapshot can include for example, a unique ID 271, a time stamp 272, a pre-change or post-change flag 273, and an identifier 274 for the data center with an associated list of infrastructure elements 275-1, 275-2, . . . . 275-n in data center 274. Each of the data center infrastructure elements 275 has one or more associated attributes 290 and one or more values 291 associated with the attributes 290. It should be understood that the exact configuration of the hierarchy including the number of infrastructure element 275 entries will of course depend upon the configuration of the data center.

The specific attributes 290 and values 291 depend upon the specific type of each infrastructure elements in the data center. For example if the infrastructure elements is a database server, the configuration attribute information may include an amount of memory, disk size, operating system, operating system version, operating system patches installed, the database application, a list of authorized login accounts, and other information. Snapshot information for infrastructure element that is a communication device such as a switch may include for example a list of active ports, associated host names, and universally unique IDs. A more specific example is discussed in greater detail below.

It should be understood that the types of infrastructure elements to which the principles described herein apply may be different, and therefore the types of configuration information stored in each snapshot 270 is also different depending not only on the data center configuration and the specific infrastructure elements, but also the preferences of the designer of the configuration management system and/or administrative user 280. These details are not a feature of the primary aspect of what is believed to be novel.

B. Change Process

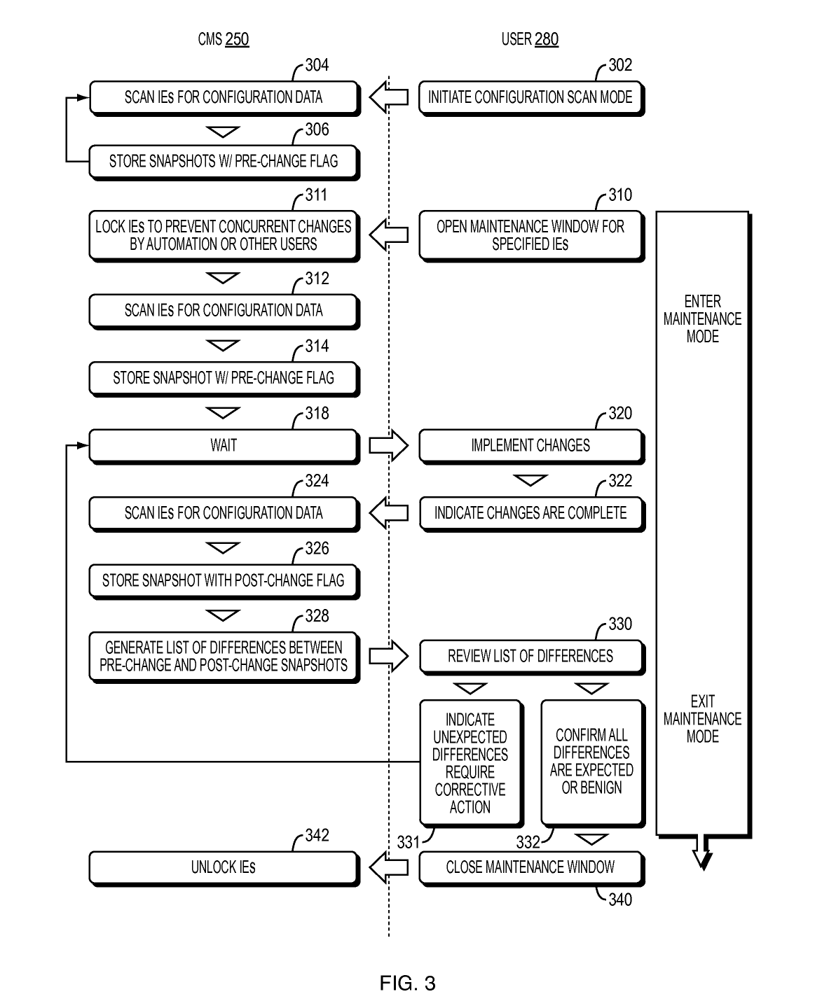

A procedure for assisting the administrative user 280 with changes by analyzing configuration data and controlling change implementation is shown in FIG. 3. The goal here is to not only maintain an accurate representation of the present configuration state of the data center 102 but also to manage the implementation of changes to the data center, by automatically identifying potential configuration errors, and therefore helping the human administrator manage more effectively.

In this figure certain actions (those to the left of the dashed line) are taken by the administrative user 280 and certain other actions (those to the right of the dashed line) are taken by the CMS 250 as an automated procedure. The actions carried out buy the CMS may be implemented by executing a stored program in a data processor.

In the first step 302 performed by user 280, a command is given to initialize the CMS 250 to enter a configuration scan mode. Upon receiving this command the CMS then enters state 304 where the infrastructure elements in data center 102 are scanned for configuration data snapshots. In this state, the CMS 250 thus communicates with the infrastructure elements in data center 102 over one or more network connections (local or remote) to retrieve the configuration information. The configuration information retrieved from the live operating data center is then captured stored in a pre-change snapshot 270, such as in the form that was described in FIG. 2.

In state 306 this snapshot is then stored in the database 260.

States 304 and 306 are then continuously executed by the CMS 250 while in the configuration scan mode. It may be desirable to scan the infrastructure elements for configuration data relatively infrequently, such as once every half hour.

Eventually a state 310 is entered in which the administrative user 280 wishes to implement a change to some aspect of the data center 102 and open a maintenance mode window. However, before the change is actually permitted to be implemented, the automated CMS procedure enters a state 311 where the infrastructure elements are set to a locked state to prevent concurrent changes from continuing to occur, whether they be via a user initiated action or automated processes. Next, a state is entered 312 where the infrastructure elements are scanned one more time for their present configuration data. That resulting snapshot, in state 314, is then stored with a pre-change flag 273 set. An equivalent action is to flag a recent snapshot that already exists in database 260.

A state 318 is then entered in which any automated procedures that might effect the configuration information are suppressed, and the configuration manager 318 then also remains idle in this wait state 318.

It should be noted that in this wait state 318 the CMS 250 does not continue scanning or storing updated snapshots. In an optional arrangement, while in maintenance mode, an additional “mode” flag may be set in the configuration data themselves to indicate that maintenance mode is currently ON. This may permit the automated procedures 285 to more effectively be stopped during the suppression wait step 318. For example, it may be preferred that while in this maintenance mode, if a server unexpectedly powers off, its normal self restart procedures are suppressed.

Eventually, once the changes are implemented in state 320 the administrative user will notify the CMS 250 in state 322 that the change is complete. At this point, the CMS 250 enters a state 324 where the infrastructure elements in the data center 102 are again scanned for configuration information. This snapshot is then stored with a post change flag set in state 326.

The CMS 250 then enters a state 328 where the pre- change and post-change snapshots are compared. Any differences in the pre-imposed change snapshot may then be determined. These are then displayed in state 330 for review by the administrative user 280.

The administrative user 280 may then wish to take one of several actions as a result of this review. For example in one state 331 the administrative user 280 may indicate that unexpected differences in the pre-change and post change snapshots require some corrective action. However in another instance such as in-state 332 administrative user may simply need to confirm that all differences between the pre-change and post change snapshots are as expected our have only a benign result.

The above process can repeat until the administrative user confirms that all differences in configuration are as intended or benign. At this point the CMS closes the maintenance mode, and the involved infrastructure elements are no longer considered to be in maintenance mode, allowing automated updates or administrative users to resume normal change operations.

3. Example Implementation of a Three VM Data Center

An example follows explaining how the process of FIG. 3 might deal with a scenario where a data center 102 consists of three virtual machines (VMs) with hostnames web01, web02, and web03. The administrator needs to make a change to remove an authorized user.

A configuration snapshot of a first VM (web01) that is configured to be a Structure Query Language (SQL) database and web server might look like this:

```
{
    Hostname: web01,
    Cpu_count: 2,
    Ram: 4,
    Operating_system: Windows Server 2008,
    Users: [
        {
            Username: Administrator,
            Last_login: 10:15:00 12/1/2011
        },
        {
            Username: bob,
            Last_login: 11:05:00 11/21/2011
        }
    ],
    Services: [
        {
            Name: wwwsvc,
            Startup: automatic,
            Run_as: Administrator
        },
        {
            Name: sqlserver,
            Startup: automatic,
            Run_as: bob
        }
    ]
}
```

The customer of the data center 102 has asked that a user—‘bob’—be removed from all VMs. To perform this change, the administrator would typically log into each VM and run a command to delete the local user.

Without assistance from the CMS of the kind described in connection with FIG. 3, it would be very easy for the administrator to inadvertently cause a configuration error as a result of this change. In this case, note that on the VM web01 a service called ‘sqlserver’ is configured to run in the context of the ‘bob’ user. The command to delete the user will not itself warn the administrator of this and its very possible that the administrator would not think to check the services configuration on each VM after running the ‘delete user’ command.

Since the services are running during the change, the customer's application would appear to be functioning normally even after the ‘bob’ user was deleted. The administrator would probably consider the change completed successfully. However, as some point in the future, when VM web01 gets rebooted or the services need to be restarted, the configuration error will then become apparent when the ‘sqlserver’ service won't start since the user ‘bob’ no longer exists.

This problem can be avoided using the CMS with the configuration error and prevention process of FIG. 3. Here's the new sequence of events:
1. Before starting the change, the administrator uses the CMS user interface to mark the VMs as going into special state known as ‘maintenance mode’.
2. Upon entering maintenance mode, the CMS will capture the live, running configuration of each VM and save them to the database with a ‘pre-change’ tag.
3. The administrator will then perform the change work, running the delete command on each VM.
4. The administrator will then use the CMS user interface to take the VMs out of ‘maintenance mode’.
5. The CMS will capture the live, running configuration of each VM again, and save them to the database with a ‘post-change’ tag.
6. The CMS will compare the ‘pre-change’ and ‘post-change’ snapshots of each VM and present the administrator with a list of differences.
7. The administrator will notice the unintended change to the ‘sqlserver’ service and can make the correction before any problems occur.

In this example, the ‘post-change’ configuration snapshot for web01 reported by the CMS 250 would look like this:

```
{
    Hostname: web01,
    Cpu_count: 2,
    Ram: 4,
    Operating_system: Windows Server 2008,
    Users: [
        {
            Username: Administrator,
            Last_login: 10:15:00 12/1/2011
        }
    ],
    Services: [
        {
            Name: wwwsvc,
            Startup: automatic,
            Run_as: Administrator
        },
        {
            Name: sqlserver,
            Startup: automatic,
            Run_as: NULL
        }
    ]
}
```

After comparing the ‘pre-change’ and ‘post-change’ snapshots (such as per states 328 of FIG. 3), a difference summary presented to the administrator in state 330 might look like this:

| Element Type | ID | Status | Old Value | New Value |
|---|---|---|---|---|
| User | bob | Deleted | | |
| Service | sqlserver | Modified | Run_as: | Run_as: |
| | | | bob | NULL |

The administrator 280 would immediately notice the NULL value for the database service and understand that this error must be corrected for the sqlserver service to start correctly.

It should be understood that the example embodiments described above may be implemented in many different ways. In some instances, the various “data processors” described herein may each be implemented by a physical or virtual general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described. As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

The computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing resources as part of a shared marketplace. By aggregating demand from multiple users in central locations, cloud computing environments can be built in data centers that use the best and newest technology, located in the sustainable and/or centralized locations and designed to achieve the greatest per-unit efficiency possible.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

Thus, while this invention has been particularly shown and described with references to example embodiments thereof, it will be understood by those skilled in the art that various changes in form and details may be made therein without departing from the scope of the invention as encompassed by the appended claims.

What is claimed is:

1. A method for automated configuration detection for a data center comprising:
scanning configuration information for infrastructure elements of the data center to create configuration snapshots, the configuration snapshots including a hierarchy of configuration attributes and associated values for the infrastructure elements;
receiving information that a change is about to be made, but not yet made, to a configuration of one or more infrastructure elements;
determining a pre-change configuration snapshot having pre-change values for the configuration attributes;
sending information that permits the change to proceed;
receiving information that the change has been completed;
determining a post-change configuration snapshot having post-change values for the configuration attributes;
comparing the comparing pre-change values to the post-change values to determine configuration differences; and
displaying the configuration differences.

2. The method of claim 1 additionally comprising:
restricting automated systems or other administrative users from changing configuration information during a maintenance mode, the maintenance mode occurring between the step of receiving information that a change is about to be made and the step of receiving information that the change has been completed.

3. The method of claim 2 wherein the automated systems include but are not limited to monitoring systems, alerting services, intrusion detection systems, and log analysis services.

4. The method of claim 1 wherein the configuration information includes information indicating whether the maintenance mode is active or not.

5. The method of claim 1 wherein the infrastructure elements are networking devices.

6. The method of claim 1 wherein the infrastructure elements include one or more routers, switches, firewalls, load balancers, storage subsystems, and servers.

7. The method of claim 1 wherein the infrastructure elements include one or more servers such as web servers, database servers, application servers, or storage servers.

8. The method of claim 7 wherein the configuration attribute information for the servers comprise an operating system type, application software, and other services, features, functions, or software.

9. The method of claim 1 wherein the infrastructure elements include one or more virtual machines and the configuration attribute information includes an operating system, hostname, installed applications, services, and user account information.

10. The method of claim 1 wherein the configuration snapshots comprise a hierarchical set of attributes for one or more infrastructure elements in the data center.

11. The method of claim 1 further comprising:
implementing a further change to the data center configuration as a result of the step of displaying the configuration differences.

12. A data processing apparatus for detecting configuration of a data center comprising:
a configuration manager system (CMS) that sends requests to infrastructure elements of the data center, and receives in response thereto configuration value information;
a user input interface, for receiving information from an administrative user that a change is about to be made, but not yet made, to a configuration of one or more of the infrastructure elements;
an information store, for storing configuration snapshots, the configuration snapshots including a hierarchy of configuration attributes and associated configuration values for the infrastructure elements, with at least one of the snapshots being a pre-change configuration snapshot having pre-change values for the configuration attributes and another snapshot being a post-change configuration snapshot;
a user output interface, for sending information that permits the administrative user to allow the change to proceed;
receiving information that the change has been completed, and in response thereto, the information store then storing the post-change configuration snapshot;
a processor for comparing the comparing pre-change values to the post-change values to determine configuration differences; and
the user output interface for further displaying the configuration differences to the administrative user.

13. The apparatus of claim 12 wherein the information store is a configuration database.

14. The apparatus of claim 12 wherein the configuration information includes information indicating whether a maintenance mode is active or not.

15. The apparatus of claim 12 wherein the infrastructure elements are networking devices.

16. The apparatus of claim 12 wherein the infrastructure elements include one or more routers, switches, firewalls, load balancers, storage subsystems, and servers.

17. The apparatus of claim 12 wherein the infrastructure elements include one or more servers such as web servers, database servers, application servers, or storage servers.

18. The apparatus of claim 17 wherein the configuration attribute information for the servers comprise an operating system type, application software, and other services, features, functions, or software.

19. The apparatus of claim 12 wherein the infrastructure elements include one or more virtual machines and the configuration attribute information includes an operating system, hostname, installed applications, services, and user account information.

20. The apparatus of claim 12 wherein the configuration snapshots comprise a hierarchical set of attributes for one or more infrastructure elements in the data center.

21. A programmable computer system product for automated configuration detection for a data center, the programmable computer system product comprising one or more data processing machines that execute instructions retrieved from a storage media, the instructions for:
scanning configuration information for infrastructure elements of the data center to create configuration snapshots, the configuration snapshots including a hierarchy of configuration attributes and associated values for the infrastructure elements;
receiving information that a change is about to be made, but not yet made, to a configuration of one or more infrastructure elements;
determining a pre-change configuration snapshot having pre-change values for the configuration attributes;
sending information that permits the change to proceed;
receiving information that the change has been completed;
determining a post-change configuration snapshot having post-change values for the configuration attributes;
comparing the comparing pre-change values to the post-change values to determine configuration differences;
displaying the configuration differences; and
accepting configuration change information in response to the displaying step.
